(19) United States
(12) Patent Application Publication
(10) Pub. No.: US 2026/0252373 A1
(43) Pub. Date: Aug. 27, 2026

(54) MIGRATING A CONFIDENTIAL VIRTUAL MACHINE FROM CLOUD TO AN EDGE DEVICE

(71) Applicant: Microsoft Technology Licensing, LLC, Redmond, WA (US)

(72) Inventors: Jin LIN, Seattle, WA (US); Giridhar VISWANATHAN, Redmond, WA (US); Michael Bishop EBERSOL, Woodinville, WA (US)

(21) Appl. No.: 19/064,454

(22) Filed: Feb. 26, 2025

(51) Int. Cl. G06F 9/455; G06F 21/57

(52) U.S. Cl. CPC G06F 9/45558; G06F 21/575; G06F 2009/4557; G06F 2009/45587

(57) ABSTRACT

Methods and systems are disclosed for migrating a confidential virtual machine (CVM) to a remote computer system. A method that is implemented in a virtualized firmware layer of a CVM involves receiving a migration signal from an orchestration component at a host partition, validating the security state of the remote system, and upon validation, removing a first secret from the virtualized firmware layer. The guest state file associated with the CVM is encrypted using a second secret from the remote system, capturing the state of the firmware layer. Subsequently, the CVM migration is initiated by transmitting the encrypted guest state file to the remote system, ensuring a secure and confidential transfer of the CVM to the designated destination.

### BACKGROUND

Virtualization technologies enable multiple virtual machines (VMs) to run on a single physical machine by abstracting the underlying hardware resources. This abstraction allows for better hardware utilization, application isolation, and simplified software and workload management. The core technology behind virtualization is the hypervisor, a software layer that manages the creation and operation of VMs by allocating resources such as the central processing unit (CPU), memory, and storage. There are two types of hypervisors: type-1 hypervisors that run directly on the hardware (e.g., bare-metal) and manage VM operations without an intermediary, and type-2 hypervisors that run on top of a host operating system (OS).

Confidential VMs (CVMs) are specialized VMs designed to enhance security and privacy for workloads that handle sensitive data. CVMs leverage hardware and software technologies to isolate and protect data and code from unauthorized access, even from higher-privilege components such as the hypervisor or host OS. CVMs can be broadly classified into hardware-based CVMs and software-based CVMs.

Hardware-based CVMs primarily rely on the underlying hardware's Trusted Execution Environments (TEEs) to create secure, isolated memory regions. Modern CPU architectures (e.g., x86, ARM) offer TEE technologies like INTEL Software Guard Extensions (SGX) and Trust Domain Extension (TDX), AMD Secure Encrypted Virtualization-Secure Nested Paging (SEV-SNP), and ARM TRUSTZONE, which provide hardware-enforced memory encryption and isolation. TEEs ensure sensitive computations are protected from unauthorized access, even if the hypervisor or host OS is compromised. These hardware-level features protect workloads that require high levels of security by preventing any external party, including a potentially malicious hypervisor, from accessing sensitive data.

Software-based CVMs, on the other hand, achieve security primarily through virtualization and software systems, such as Virtualization-Based Security (VBS) from MICROSOFT. Rather than relying solely on hardware isolation, these systems utilize the hypervisor and a Secure Kernel to establish secure memory regions and apply security policies. While the hypervisor is responsible for creating Virtual Trust Levels (VTLs), VBS enforces the isolation of these VTLs and ensures that sensitive operations remain confined to protected environments. VBS typically operates with multiple VTLs, each providing a distinct level of trust. For example, VTL0 corresponds to the standard OS level, where regular applications and user processes execute, while VTL1 is used to protect sensitive functions, such as credential management and cryptographic operations. Code running in VTL1 remains protected even if the OS at VTL0 is compromised. By maintaining strict isolation between trusted and untrusted components, VBS ensures that sensitive operations are shielded from tampering or compromise.

Regardless of whether a CVM is hardware-or software-based, many implementations utilize a secure execution layer or hardware compatibility layer (HCL). The HCL is a virtualized firmware that operates within an isolated environment inside the VM (e.g., created using TEE technologies, VBS, etc.), providing an additional layer of security. In some examples, the HCL is responsible for managing cryptographic operations, controlling access to hardware resources, and ensuring the overall integrity of sensitive data. In some implementations, one function of the HCL is managing a virtual trusted platform module (vTPM), which securely stores cryptographic keys, certificates, and other security-related information. The vTPM ensures that cryptographic operations such as data encryption, signing, and attestation are executed securely and are resistant to tampering or eavesdropping. This protection is particularly useful in CVMs, where sensitive data may be processed within untrusted hosting environments.

The combined use of TEEs in hardware-based CVMs, VBS in software-based CVMs, and the HCL across both models provides a robust framework for executing sensitive workloads in isolated, trusted environments. This multi-layered approach to confidentiality ensures that data and code remain secure even in the face of vulnerabilities in the underlying infrastructure.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products implemented by a virtualized firmware layer of a confidential virtual machine (CVM) that executes in a computer system that includes a processor system, including receiving a signal to migrate the CVM to a remote computer system, the signal having been initiated by an orchestration component at a host partition of the computer system; validating a security state of the remote computer system; and after validating the security state of the remote computer system: removing a first secret from the virtualized firmware layer; encrypting a guest state file associated with the CVM using a second secret received from the remote computer system, the guest state file including a state of the virtualized firmware layer; and initiating a migration of the CVM to the remote computer system, including sending the guest state file to the remote computer system.

In some aspects, the techniques described herein relate to methods, systems, and computer program products implemented in a computer system that includes a trusted platform module (TPM), including sending a request to a virtual machine (VM) hosting service for migrating a CVM that is executing at the VM hosting service to the computer system; sending measurement information to the VM hosting service, the measurement information including one or more of, a first claim associated with the TPM; a second claim associated with a host OS in the computer system; a secure boot status of the computer system; an identity encryption key generated by the computer system; or an identity signing key generated by the computer system; receiving a guest state file from the VM hosting service, the guest state file including a first state of a first virtualized firmware layer instance of the CVM; and starting the CVM at the computer system based on the guest state file, including: creating a guest partition as the CVM, the guest partition including a first privilege context and a second privilege context, the first privilege context being restricted from accessing memory allocated to the second privilege context; starting a second virtualized firmware layer instance within the second privilege context, including creating a virtual TPM (vTPM) within the second virtualized firmware layer instance; and populating a second state of the second virtualized firmware layer instance from the guest state file.

In some aspects, the techniques described herein relate to a system including a VM host computer system including a first processor system and a first computer storage medium that stores first computer-executable instructions that are executable by the first processor system to: receive a signal to migrate a CVM from the VM host computer system to a client computer system, the signal having been initiated by an orchestration component at a host partition of the VM host computer system; validate a security state of the client computer system based on measurement information received from the client computer system that includes a claim associated with a TPM in the client computer system; and after validating the security state of the client computer system: remove a first secret from a first virtualized firmware layer instance of the CVM; and send a guest state file to the client computer system, the guest state file including a state of the first virtualized firmware layer instance.

In some aspects, the techniques described herein relate to a system including a client computer system, including a second processor system, the TPM, and a second computer storage medium that stores second computer-executable instructions that are executable by the second processor system to: send a request to a VM hosting service for migrating the CVM to the client computer system; send the measurement information to the VM host computer system; receive the guest state file from the VM host computer system; and start the CVM at the client computer system based on the guest state file, including: creating a guest partition as the CVM, the guest partition including a first privilege context and a second privilege context, the first privilege context being restricted from accessing memory allocated to the second privilege context; starting a second virtualized firmware layer instance within the second privilege context, including creating a vTPM within the second virtualized firmware layer instance; and populating a second state of the second virtualized firmware layer instance from the guest state file.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture for migrating a confidential VM (CVM) or a trusted-launch VM (virtual machine), from a VM host computer system to a remote client computer system;

FIG. 2 illustrates an example of a VM host computer system for migrating a CVM to a remote client computer system;

FIG. 3 illustrates an example of a client computer system for receiving a CVM from a VM host computer system;

FIG. 4 illustrates a flow chart of an example method for migrating a CVM from a VM host computer system to a remote client computer system; and

FIG. 5 illustrates a flow chart of an example method for migrating a CVM from a client computer system to a remote VM host computer system.

### DETAILED DESCRIPTION

Virtual machine (VM) hosting services may offer cloud-based trusted-launch VMs (TVMs) for remote customer use, e.g., via remote display technologies such as remote desktop protocol (RDP), virtual network computing (VNC), or simple protocol for independent computing environments (SPICE). Although TVMs and confidential VMs (CVMs) are distinct constructs, some embodiments may implement a TVM as a type of CVM that includes a virtual Trusted Platform Module (vTPM) within a hardware compatibility layer (HCL). The fundamental difference between a TVM and a CVM lies in how much of the host operating system (OS) resides within the trust boundary. For a TVM, the entire host OS, including the host VTL0 code, is trusted. In contrast, for a software-based CVM, the host VTL0 is not trusted, while the hypervisor and host VTL1 remain in the trusted computing base (TCB). For a hardware-based CVM, only the System-on-Chip (SoC) vendor hardware and its associated microcode are trusted, and the host OS, including the hypervisor, is untrusted.

Because of these differing trust boundaries, hosting services face significant challenges in enabling the secure migration of a CVM or a TVM to a client's edge device, such as an on-premises server or an end-user device (e.g., a desktop computer, laptop, or tablet). The difficulties include maintaining the confidentiality of the VM's memory contents in a potentially hostile edge environment and not exporting/exposing the secrets and certificates associated with the hosting environment to a potentially hostile environment of the client device. These unresolved issues currently prevent the secure migration of such trusted or confidential VMs out of the cloud environment and onto customer-controlled infrastructure.

The embodiments described herein address this unsolved challenge and provide a method and system for securely migrating a CVM (including a TVM) to a client device, such as an on-premises server or an end-user device, while maintaining the confidentiality of the migrated CVM and any TPM secret(s) the CVM may possess. The method includes negotiations between orchestration services at a VM host and the client device, various functions executed in the CVM's HCL (e.g., virtualized firmware) to safeguard VM host secrets and to ready the CVM for migration to the client device, and functions at the client device to import and securely boot the CVM using a vTPM. The method ensures the protection of vTPM secrets at the VM host throughout the migration process and maintains the confidentiality and integrity of the CVM, even when it runs on a client device.

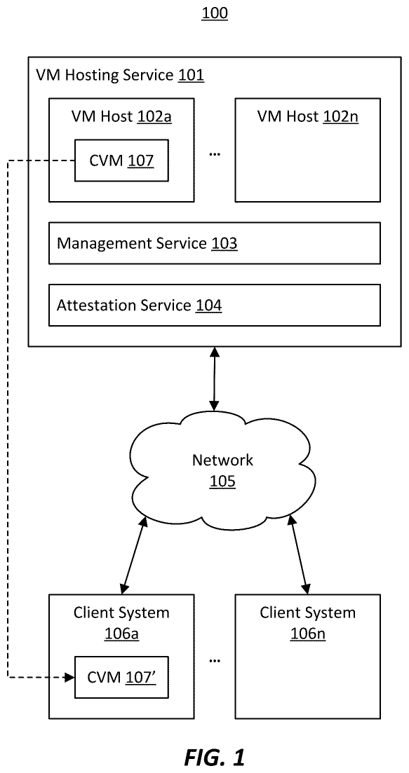

FIG. 1 illustrates an example of computing environment 100 for migrating a CVM, such as a TVM, from a VM host computer system to a remote client computer system. As shown, computing environment 100 includes a VM hosting service 101, which includes at least one VM host 102a. As shown, however, VM hosting service 101 can include any number of VM hosts (e.g., VM host 102a to VM host 102n). VM hosting service 101 also includes a management service 103 that manages tenant accounts, VM permissions, VM deployment, and the like. VM hosting service 101 also includes, or at least utilizes, an attestation service 104 that ensures trust and security within computing environment 100. The attestation service 104 validates the security state of computer systems based on measurement information obtained from those systems. This measurement information typically originates from TPMs, which are hardware-based security components designed to provide secure storage of cryptographic keys, certificates, and other security-related information, as well as cryptographic operations.

Computing environment 100 also shows that VM hosting service 101 interconnects, via a network 105, such as the Internet, to a client system 106a. As shown, however, VM hosting service 101 can interconnect with any number of client systems (e.g., client system 106a to client system 106n). In embodiments, each client system is an edge device, such as an on-premises server or an end-user device (e.g., laptop computer, desktop computer, tablet computer, smartphone) operated by a customer of VM hosting service 101.

As shown, VM host 102a hosts a CVM 107 (confidential VM) associated with client system 106a. For example, VM hosting service 101 may offer CVM 107 as a cloud-based TVM and provide client system 106a with remote access (e.g., via RDP, VNC, or SPICE) to a desktop user interface of CVM 107. In addition, however, VM hosting service 101 also enables migration of CVM 107 to client systems, such as client system 106a (e.g., a cloud-to-edge migration of CVM 107), as indicated by CVM 107′ at client system 106a and an arrow that connects CVM 107 to CVM 107′. In the embodiments described herein, VM host 102a and client system 106a each take actions to ensure the confidentiality of CVM 107 (e.g., preventing access to the memory of CVM 107 by applications executing at client system 106a), as well as ensuring that secrets stored at VM host 102a in connection with its hosting of CVM 107 are not leaked to client system 106a.

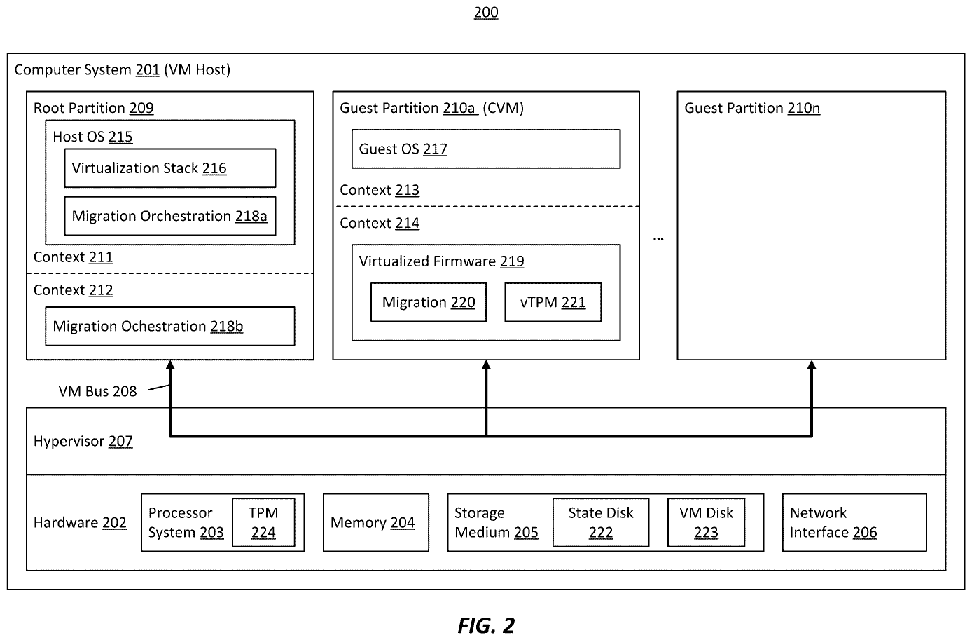

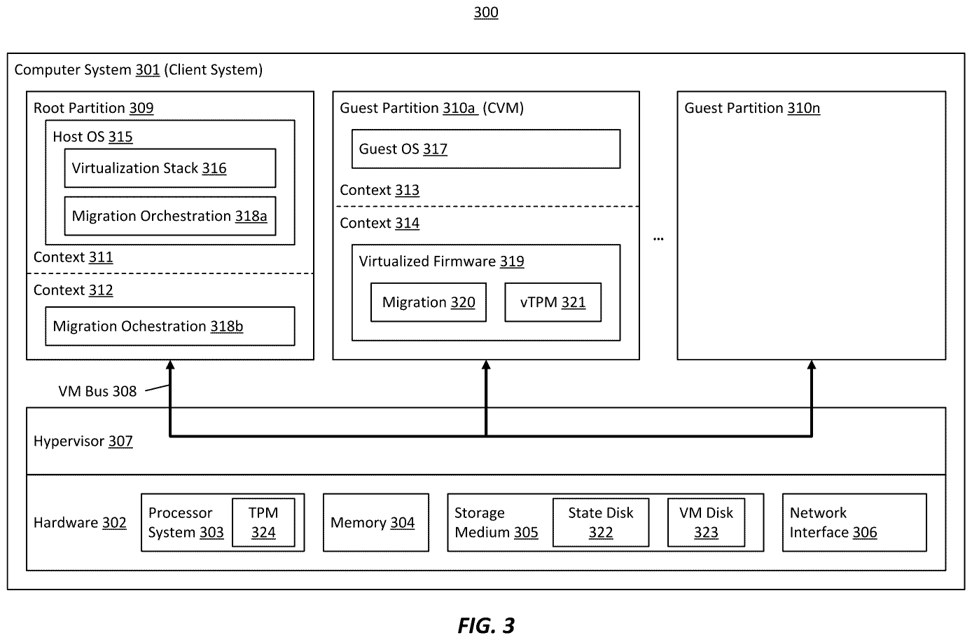

To further illustrate the cloud-to-edge migration of CVM 107 from VM host 102 a to client system 106 a, FIG. 2 illustrates an example 200 of a VM host computer system (e.g., VM host 102a) for migrating a CVM to a remote client computer system, while FIG. 3 illustrates an example 300 of a client computer system (e.g., client system 106a) for receiving a CVM from a VM host computer system.

Referring to FIG. 2, example 200 shows a computer system 201 (system 201) comprising hardware 202. Examples of hardware 202 include a processor system 203 (e.g., a single processor or a plurality of processors) that includes an integrated TPM 224, a memory 204 (e.g., system or main memory), a storage medium 205 (e.g., a single computer-readable storage medium, or a plurality of computer-readable storage media), and a network interface 206 (e.g., one or more network interface cards) for interconnecting to one or more other computer systems. In example 200, a hypervisor 207 executes directly on hardware 202.

In general, the hypervisor 207 partitions hardware resources (e.g., processor system 203, memory 204, I/O resources) among a root partition 209 (alternatively called a host partition), within which a host OS 215 executes, as well as one or more guest partitions 210, or guest VMs, (e.g., guest partition 210a to memory context 210n) within which corresponding guest OSs execute (e.g., guest OS 217 in guest partition 210a). The hypervisor 207 also enables regulated communications between partitions via a VM bus 208. The host OS 215 includes a virtualization stack 216, which manages guest VMs (e.g., memory management, VM guest lifecycle management, device virtualization) via one or more application program interface (API) calls to the hypervisor 207 via VM bus 208.

In embodiments, hypervisor 207 further divides partitions into differently-privileged memory contexts. For example, in example 200, hypervisor 207 has divided root partition 209 into memory context 211 and memory context 212 and has divided guest partition 210a into memory context 213 and memory context 214. In embodiments, memory context 211 in root partition 209 and memory context 213 in guest partition 210a are lower privileged memory contexts (e.g., when compared to memory context 212 and memory context 214, respectively), and memory context 212 in root partition 209 and memory context 214 in guest partition 210a are higher privileged memory contexts (e.g., when compared to memory context 211 and memory context 213, respectively). In these embodiments, memory context 211 having a lower privilege than memory context 212 means that memory context 211 cannot access memory allocated to memory context 212, though memory context 212 may be able to access memory allocated to memory context 211 in some embodiments. Similarly, memory context 213 having a lower privilege than memory context 214 means that memory context 213 cannot access memory allocated to memory context 214, though memory context 214 may be able to access memory allocated to memory context 213 in some embodiments.

Some embodiments create memory contexts 211-214 by leveraging second-level address translation (SLAT) to create isolated memory contexts within a given partition. For example, HYPER-V includes virtualization-based security (VBS) technology that relies on SLAT. Using VBS, the HYPER-V hypervisor can divide a partition's memory into different virtual trust levels (VTLs), including, for example, a higher-privileged VTL (e.g., VTL1) and a lower-privileged VTL (e.g., VTL0). In these environments, the OS (e.g., host OS 215, guest OS 217) and standard user-mode applications execute within the lower-privileged VTL (e.g., VTL0), while separate software executes in the higher-privileged VTL (e.g., VTL1) and provides services to the OS. Thus, in embodiments, hypervisor 207 creates memory context 211 and memory context 212 using one or more SLAT tables that map system physical addresses within memory 204 to guest physical addresses seen by root partition 209, and hypervisor 207 creates memory context 213 and 214 using one or more SLAT tables that map system physical addresses within memory 204 to guest physical addresses seen by guest partition 210a. In these embodiments, these mappings prevent memory context 211 from accessing memory allocated to memory context 212 and prevent memory context 213 from accessing memory allocated to context 214. Thus, in one example, hypervisor 207 is the HYPER-V hypervisor, which creates different privilege contexts, with memory context 212 and context 214 corresponding to a higher privileged VTL (e.g., VTL1), and memory context 211 and memory context 213 corresponding to a lower privileged VTL (e.g., VTL0).

Other embodiments may create contexts 211-214 using nested virtualization, e.g., in which each partition operates a hypervisor that sub-partitions that partition into different contexts. In these embodiments, a hypervisor operating within root partition 209 prevents memory context 211 from accessing memory allocated to memory context 212, and a hypervisor operating within guest partition 210a prevents context 214 from accessing memory allocated to memory context 213. Other embodiments are also possible, such as embodiments in which hypervisor 207 creates both a partition and its sub-partitions.

In example 200, guest partition 210 a is a CVM. Thus, context 214 executes a virtualized firmware 219, or HCL, separately from memory context 213 and provides services to memory context 213. In embodiments, virtualized firmware 219 includes hypervisor-like functionality and thus operates, at least in part, as a para-virtualization layer (e.g., a “paravisor”) and/or a VM monitor (VMM). Examples of services that virtualized firmware 219 may provide to memory context 213 include emulated hardware (e.g., an emulated storage controller), baseboard management controller functionality for monitoring and managing a guest partition, a vTPM 221, and the like. Because guest partition 210a includes memory context 211, guest partition 210a may operate as a CVM.

In example 200, root partition 209 includes a migration orchestration component 218, while guest partition 210a includes a migration component 220. Migration orchestration component 218 and migration component 220 coordinate to securely migrate the CVM of guest partition 210a to a client computer system (e.g., system 301, FIG. 3). In example 200, migration orchestration component 218 is illustrated as including a portion residing within memory context 212 (migration orchestration component 218b) and a portion residing within host OS 215 (migration orchestration component 218a). In embodiments, due to its interactions with sensitive CVMs, positioning migration orchestration component 218b within memory context 212 protects it from potentially hostile software residing in memory context 211. However, the architecture or arrangement migration orchestration component 218 within root partition 209 may vary.

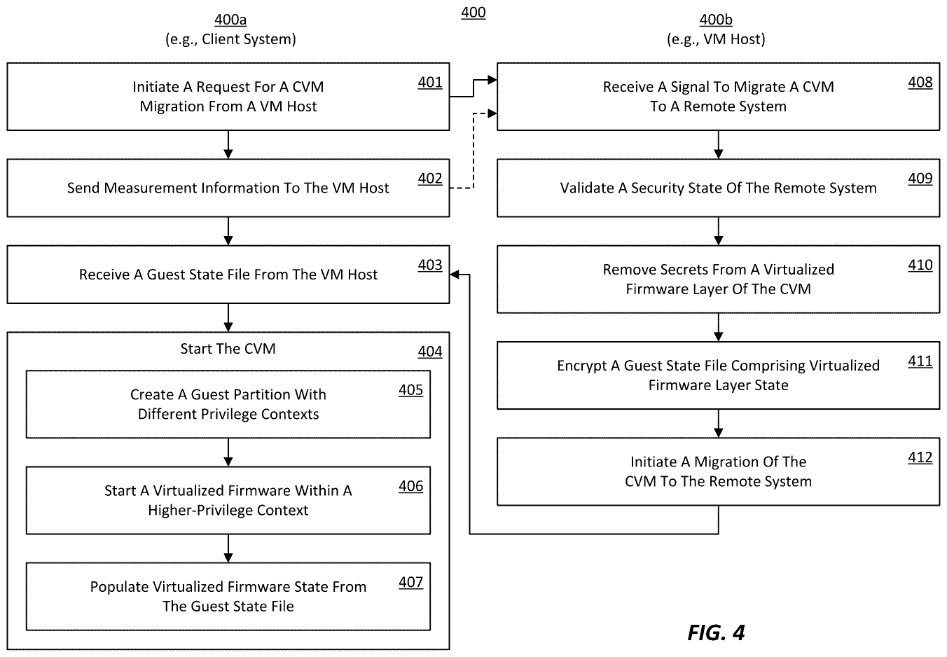

Migration component 220 is illustrated as residing within context 214 as part of virtualized firmware 219. This enables migration component 220 to operate independently of guest OS 217 and to manage sensitive data contained in virtualized firmware 219 in a secure manner. In general, and as will be described further in connection with FIG. 4, migration orchestration component 218 initiates migration of the CVM of guest partition 210a to a client computer system (e.g., system 301, FIG. 3) based on a request received from the client computer system. Based on the initiation by migration orchestration component 218, the migration component 220 prepares guest partition 210a for migration and initiates the migration when ready.

Referring to FIG. 3, example 300 shows a computer system 301 (system 301) comprising hardware 302. Similar to system 201, examples of hardware 302 include a processor system 303 that includes an integrated TPM 324, a memory 304, a storage medium 305, and a network interface 306. Although it is a client device, which may include an end-user device like a desktop computer, laptop computer, or tablet computer, example 300 illustrates that system 301 is configured with a hypervisor 307, similar to system 201. Thus, system 301 includes a root partition 309 (including a host OS 315 and virtualization stack 316), one or more guest partitions 310 (e.g., guest partition 310a to guest partition 310n, including guest OSs such as guest OS 317), and a VM bus 308. In example 300, like hypervisor 207, hypervisor 307 is capable of sub-partitioning partitions, shown as context 311 and context 312 in root partition 309 and as context 313 and context 314 in guest partition 310a. In general, context 311 is analogous to memory context 211, context 312 is analogous to memory context 212, context 313 is analogous to memory context 213, and context 314 is analogous to context 214.

In example 300, root partition 309 includes a migration orchestration component 318. In example 300, migration orchestration component 318 is illustrated as including a portion residing within context 312 (migration orchestration component 318b), e.g., to protect it from potentially hostile software in context 311, and a portion residing within host OS 315 (migration orchestration component 318a). However, the architecture or arrangement migration orchestration component 318 within root partition 309 may vary. In general, and as will be described further in connection with FIG. 4, migration orchestration component 318 requests the migration of a CVM from system 201 to system 301 and coordinates the creation of that CVM at system 301, e.g., as guest partition 310a.

Example 200 also shows a state disk 222 and a VM disk 223 backing the CVM of guest partition 210 a, while example 300 also shows a state disk 322 and a VM disk 323 backing the CVM of guest partition 310a. While these disks are shown as residing in local storage (e.g., storage medium 205, storage medium 305), they may alternatively reside in system memory (e.g., memory 204, memory 304) or on a remote storage device (e.g., a storage server or service).

Embodiments are now described in connection with FIG. 4, which illustrates a flow chart of an example method 400 for migrating a CVM from a VM host computer system to a remote client computer system. In embodiments, instructions for implementing method 400 are encoded as computer-executable instructions (e.g., migration component 220, migration orchestration component 318, migration component 320) stored on a computer storage medium (e.g., storage medium 205, storage medium 305) that are executable by a processor system (e.g., processor system 203, processor system 303) to cause a computer system (e.g., system 201, system 301) to perform method 400.

The following discussion now refers to a number of methods and method acts. Although the method acts are discussed in specific orders or are illustrated in a flow chart as occurring in a particular order, no order is required unless expressly stated or required because an act is dependent on another act being completed before the act is performed.

Method 400 includes acts (e.g., act 401 to act 407, shown as method 400a) performed at a client computer system, e.g., by migration orchestration component 318 at system 301. Method 400 also includes acts (e.g., act 408 to act 412, shown as method 400b) performed at a VM host computer system, e.g., a virtualized firmware layer (e.g., migration component 220) of a CVM (e.g., guest partition 210a at system 201). Thus, method 400a and method 400b may be distinct methods (e.g., performed at client system 106a/system 301 and VM host 102a/system 201, respectively) or a single method performed in a networked computing environment (e.g., computing environment 100) that includes both client system 106a/system 301 and VM host 102a/system 201.

Referring to FIG. 4, method 400a comprises act 401 of initiating a request for a CVM migration from a VM host. In some embodiments, act 401 comprises sending a request to a VM hosting service for migrating a CVM executing at the VM hosting service to the computer system. For example, migration orchestration component 318a sends a request to VM hosting service 101, requesting that the CVM of guest partition 210a be migrated to system 301. FIG. 4 illustrates this request via an arrow connecting act 401 to act 408. In one example, a user associated with system 301 utilizes a VM management interface (e.g., web interface, application programming interface) presented by or associated with management service 103 to request that the CVM be migrated to system 301. In embodiments, as part of making this request, the migration orchestration component 318a authenticates with management service 103 using an identity (e.g., user account) associated with the CVM, thereby ensuring that system 301 is associated with an authorized entity. Thus, in some embodiments, method 400a further comprises authenticating with the VM hosting service using an identity associated with the CVM. Some embodiments additionally authorize, with management service 103, that the authenticated account is permitted to perform a CVM migration operation.

Based on act 401, method 400b comprises act 408 of receiving a signal to migrate a CVM to a remote system. In embodiments, act 408 comprises receiving a signal to migrate the CVM to a remote computer system, the signal having been initiated by an orchestration component at a host partition of the computer system. For example, migration component 220 receives a signal from migration orchestration component 218 over VM bus 208, the signal indicating that the CVM of guest partition 210a is to be migrated to system 301. Notably, this signal could involve multiple interactions between a client (e.g., client system 106a, computer system 201) and a host (e.g., VM host 102a, system 201), such as the exchange of a number-used-once (nonce), to ensure the client measured security state (see act 402) current and not a replay (e.g., of measurements of an old state from that client). In embodiments, migration orchestration component 218 initiates the signal after receiving an instruction from management service 103, e.g., after management service 103 has verified ownership of the CVM by an identity associated with system 301.

In some embodiments, the orchestration component is isolated from a host OS executing in the host partition. For example, in some embodiments, migration component 220 receives the signal from migration orchestration component 218b in memory context 212. Notably, using migration orchestration component 218b in memory context 212 can provide an added security measure by ensuring that the ultimate decision to migrate the CVM is made by a component executing in a controlled location isolated from a general-purpose OS. In other embodiments, however, the orchestration component may execute within the context of the host OS. For example, migration component 220 receives the signal from migration orchestration component 218a in memory context 211. In either scenario, in embodiments, the migration component 220 may receive the signal to migrate the CVM via the VM bus 208; for example, in some implementations, virtualized firmware 219 may lack network access (e.g., to promote the security of virtualized firmware 219, to reduce a code attack surface of virtualized firmware 219) and communicate with root partition 209 exclusively via VM bus 208.

After act 408, method 400b also comprises act 409 of validating a security state of the remote system. In embodiments, act 409 comprises validating a security state of the remote computer system. For example, the migration component 220 validates a security state of system 301. Notably, this validation may be in addition to validation(s) performed by management service 103 and/or migration orchestration component 218. In embodiments, validating the security state of system 301 includes utilizing attestation service 104 to attest one or more security claims received from system 301. In some examples, attestation service 104 operates by receiving security claims from system 301, which may include information such as the status of secure boot, the presence of TPM keys, and the versions of installed software. These claims are then evaluated by attestation service 104 to determine their validity. The attestation service may issue an attestation certificate based on the evaluation, which serves as proof that system 301 meets the required security standards. This certificate can be used by other components within the system to verify the security state of system 301 before proceeding with further operations. In embodiments, validating the security state of system 301 comprises migration component 220 obtaining measurement information from system 301, migration component 220 sending the measurement information to attestation service 104, and migration component 220 receiving an attestation status from the attestation service, with the attestation status indicating the security state of the system 301 (e.g., whether the security state meets a set of security requirements, or fails the of security requirements). In embodiments, the migration component 220 performs these communications via migration orchestration component 218 (e.g., migration orchestration component 218a in host OS 215).

Referring to method 400a, to facilitate this security state validation by migration component 220, method 400a also comprises act 402 of sending measurement information to the VM host. In embodiments, act 402 comprises sending measurement information to the VM hosting service (e.g., which forwards that information to system 201) or sending the measurement information to system 201 directly. The particular information included in the measurement information can vary, but in embodiments, it includes one or more of 1) a claim associated with TPM 324, a claim associated with a host OS 315, 2) a secure boot status of system 301, 3) an identity encryption key (IDKe) generated by system 301, or 4) an identity signing key (IDKs) generated at context 312 to be specific to and measured into TPM 324. An IDKe is a cryptographic key used to encrypt data inside VBS, while an IDKs is used to digitally sign identity information.

In some embodiments, system 301 sends the measurement information to the VM hosting service based on a request. For example, migration component 220 initiates a request to system 301 as part of act 409. Thus, in some embodiments, method 400b comprises receiving a request from the VM hosting service, the request for obtaining the measurement information. FIG. 4 illustrates this embodiment via a broken arrow connecting act 402 to act 408.

Method 400b also comprises act 410 of removing secrets from a virtualized firmware layer of the CVM. In some embodiments, act 410 comprises removing a secret from the virtualized firmware layer. The particular information removed can vary, but in embodiments, removing secrets from the virtualized firmware layer includes migration component 220 removing one or more of 1) an attestation identity key (AIK) of vTPM 321, 2) a certificate issued on this AIK, 3) an endorsement key (EK) of 321, or 4) a certificate issued by a hosting service provider. In embodiments, the AIK is a key generated by vTPM 321 for platform authentication and attestation purposes. In embodiments, the EK is an asymmetric key pair generated and managed by vTPM 321, which is used to bootstrap trust in vTPM 321. In embodiments, the EK of vTPM 321 is rooted in an EK of TPM 224. Notably, the removal of secrets from virtualized firmware 219 in act 410 ensures the security and integrity of system 201 (e.g., because the EK of vTPM 321 is rooted in an EK of TPM 224) and any certificates issued to the CVM by VM hosting service 101. Notably, in act 410, the migration component 220 may intentionally leave some secrets in virtualized firmware 219. For example, the migration component 220 may preserve a data encryption key (e.g., BITLOCKER, FILEVAULT, dm-crypt) used to encrypt/decrypt VM disk 223 backing the CVM. In general, the migration component 220 removes secrets that could compromise the security of system 201, and preserves secrets that are needed to operate the migrated CVM at system 301.

Method 400b also comprises act 411 of encrypting a guest state file comprising virtualized firmware layer state. In some embodiments, act 411 comprises encrypting a guest state file associated with the CVM using a secret received from the remote computer system, the guest state file including a state of the virtualized firmware layer. For example, migration component 220 encrypts state disk 222, which backs at least virtualized firmware 219. In one example, migration component 220 encrypts state disk 222 using a symmetric encryption algorithm, such as one based on the advanced encryption standard (AES). In embodiments, the migration component 220 encrypts state disk 222 with a key received from system 301, such as an IDKe received from system 301 and associated with context 312 as part of measurement information. Thus, in some embodiments, obtaining the measurement information from the remote computer system (e.g., in act 408 or act 409) includes receiving the IDKe, and in act 411, encrypting the guest state file using the second secret received from the remote computer system comprises encrypting the guest state file with the IDKe. In other embodiments, migration component 220 encrypts state disk 222 with a newly generated key, which is communicated to system 301. In embodiments, this newly generated key is encrypted to the IDKe so that it is available only to context 312.

Method 400b also comprises act 412 of initiating a migration of the CVM to the remote system. In some embodiments, act 412 comprises initiating a migration of the CVM to the remote computer system. For example, the migration component 220 initiates the migration of the CVM of guest partition 210a to system 301. In embodiments, migration component 220 with migration orchestration component 318 to perform act 412, such as to suspend guest partition 210a, destroy guest partition 210a, and communicate data to system 301. FIG. 4 illustrates this migration via an arrow connecting act 412 to act 403.

In embodiments, initiating the migration of the CVM to the remote computer system also includes sending the guest state file to the remote computer system. For example, migration component 220 and/or migration orchestration component 218 sends state disk 222 to system 301. In turn, method 400a comprises act 403 of receiving a guest state file from the VM host. In embodiments, act 403 comprises receiving the guest state file from the VM hosting service, the guest state file including a first state of a first virtualized firmware layer instance of the CVM. For example, migration orchestration component 318 receives state disk 222 from system 201, as represented by state disk 322 in storage medium 305.

In embodiments, initiating the migration of the CVM to the remote computer system also includes sending a VM disk image to the remote computer system. For example, migration component 220 and/or migration orchestration component 218 sends VM disk 223 to system 301. In turn, method 400a comprises act 403 of receiving a VM disk image from the VM host. In embodiments, act 403 comprises receiving the VM disk image from the VM hosting service. For example, migration orchestration component 318 receives VM disk 223 from system 201, as represented by VM disk 323 in storage medium 305. In alternative embodiments, rather than sending a VM disk to system 301, system 301 accesses the VM disk from a remote source.

Method 400a also comprises act 404 of starting the CVM. In embodiments, act 403 comprises starting the CVM at the computer system based on the guest state file. Act 404 includes act 405 of creating a guest partition with different privilege contexts. In embodiments, act 405 comprises creating a guest partition as the CVM, the guest partition including a first privilege context and a second privilege context, the first privilege context being restricted from accessing memory allocated to the second privilege context. For example, migration orchestration component 318 initiates the creation of guest partition 310a by hypervisor 307, which includes context 313 and context 314.

In some embodiments, before starting the CVM, migration orchestration component 318 validates an attestation status of system 301. Thus, for example, migration orchestration component 318 sends measurement information (e.g., like that used in act 409) to an attestation service (e.g., attestation service 104) and receives an attestation status from the attestation service, with the attestation status indicating a security state of the system 301 that enables the computer system to start the CVM. In embodiments, if the security state of system 301 changes from the state when the CVM was migrated to the client device, then decrypting the guest state file fails. In this situation, the CVM cannot be started on system 301 until system 301 gets back to the same secure state used to migrate the CVM (e.g., the state communicated in act 402).

Act 404 also includes act 406 of starting a virtualized firmware within a higher-privilege context. In embodiments, act 406 comprises starting a second virtualized firmware layer instance within the second privilege context, including creating a vTPM within the second virtualized firmware layer instance. For example, migration orchestration component 318 coordinates the startup of the CVM within guest partition 310a, which includes starting virtualized firmware 319 from, e.g., state disk 322 and/or VM disk 323. Notably, starting virtualized firmware 319 includes creating vTPM 321, e.g., with its own EK and AIK.

Act 404 also includes act 407 of populating virtualized firmware state from the guest state file. In embodiments, act 407 comprises populating a second state of the second virtualized firmware layer instance from the guest state file. For example, migration orchestration component 318 coordinates the population of at least a portion of the state of virtualized firmware 319 from state disk 322. Notably, as explained in connection with act 411, state disk 322 has been encrypted at system 201. Thus, in embodiments, act 407 includes decrypting state disk 322. For example, in some implementations, the guest state file is encrypted with an IDKe generated by system 301 (e.g., by context 314), and act 407 includes decrypting the guest state file using the IDKe.

As explained in connection with act 412, in some situations, the state disk 322 may include a data encryption key, such as BITLOCKER, FILEVAULT, or dm-crypt. In these situations, method 400a may further comprise decrypting the VM disk image with the data encryption key.

Thus, methods and systems are disclosed for migrating a CVM to a remote computer system. A method that is implemented in a virtualized firmware layer of the CVM involves receiving a migration signal from an orchestration component at a host partition, validating the security state of the remote system, and upon validation, removing secrets from the virtualized firmware layer. The guest state file associated with the CVM is encrypted using a secret from the remote system, capturing the state of the firmware layer. Subsequently, the CVM migration is initiated by transmitting the encrypted guest state file to the remote system, ensuring a secure and confidential transfer of the CVM to the designated destination.

The preceding disclosure has focused primarily on a cloud-to-edge migration of a CVM. Some embodiments also enable an edge-to-cloud migration of a CVM that was previously migrated to an edge device. In other words, after a cloud-to-edge migration of a CVM, as already described in connection with FIGS. 1-4 (e.g., from VM host 102a to client system 106a), some embodiments enable that CVM to be migrated back to the cloud (e.g., from client system 106a to one of VM host 102a to VM host 102n).

In embodiments, an edge-to-cloud migration of a CVM includes measures to ensure that the security posture of a CVM migrating from edge to cloud is consistent with the security posture of the CVM when it was previously migrated from cloud to edge. Stated differently, embodiments ensure that the trusted computing base (TCB) of the CVM remains consistent and uncompromised throughout the transition.

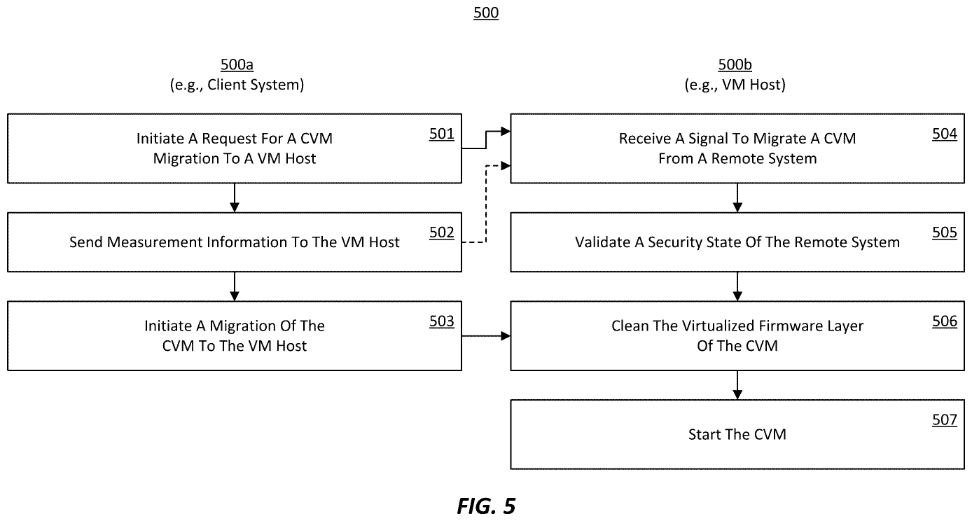

Edge-to-cloud CVM migration embodiments are now described in connection with FIG. 5, which illustrates a flow chart of an example method 500 for migrating a CVM from a client computer system to a remote VM host computer system. In embodiments, instructions for implementing method 500 are encoded as computer-executable instructions (e.g., migration component 220, migration orchestration component 318, migration component 320) stored on a computer storage medium (e.g., storage medium 205, storage medium 305) that are executable by a processor system (e.g., processor system 203, processor system 303) to cause a computer system (e.g., system 201, system 301) to perform method 500.

Method 500 includes acts (e.g., act 501 to act 503, shown as method 500a) performed at a client computer system. Method 500 also includes acts (e.g., act 504 to act 507, shown as method 500b) performed at a VM host computer system. Thus, method 500a and method 500b may be distinct methods performed at different computer systems or a single method performed in a networked computing environment.

In embodiments, method 500 begins after authenticating the client system from which a CVM will be migrated. For example, VM hosting service 101 or VM host 102a authenticates client system 106a, or system 201 authenticates system 301. In embodiments, this authentication includes determining if the client system (or a credential associated therewith) is authorized to initiate an edge-to-cloud migration and/or determining if a subject CVM (e.g., CVM 107′, guest partition 310a) is authorized for an edge-to-cloud migration. For instance, VM hosting service 101 or VM host 102a determines if a user associated with system 301 is authorized by policy to initiate an edge-to-cloud migration and/or if CVM 107′/guest partition 310 a is authorized by policy to be migrated from edge-to-cloud.

Referring to FIG. 5, method 500a comprises act 501 of initiating a request for a CVM migration to a VM host. In some embodiments, act 501 comprises sending a signal to a VM host computer system, the signal requesting to migrate a CVM from a remote computer system to the VM host computer system. FIG. 5 illustrates this request via an arrow connecting act 501 to act 504. Referring to FIGS. 2 and 3, in some examples, the signal is initiated by migration orchestration component 318b or migration component 320 and is directed at system 201.

Based on act 501, method 500b comprises act 504 of receiving a signal to migrate a CVM from a remote system. In some embodiments, act 504 comprises receiving a signal to migrate a CVM from the remote computer system to the VM host computer system, the signal having been initiated by the remote computer system. Referring to FIG. 2, in some examples, the signal is received by system 201 and processed at migration orchestration component 218b.

After act 504, method 500b also comprises act 505 of validating a security state of the remote system. Referring to method 500a, to facilitate this security state validation, method 500a also comprises act 502 of sending measurement information to the VM host.

In some embodiments, system 201 determines if the measurement information sent by system 301 in act 402, and validated by system 201 in act 409, matches (or is equivalent to) measurement information sent by system 301 in act 502. Thus, in some embodiments of act 505, validating the security state of the remote computer system includes obtaining measurement information from the remote computer system and determining if the obtaining measurement information matches prior measurement information received from the remote computer system. Similar to method 400, in embodiments, obtaining the measurement information from the remote computer system includes receiving one or more of a first claim associated with a TPM in the remote computer system, a second claim associated with a host operating system in the remote computer system, a secure boot status of the remote computer system, an IDKe generated by the remote computer system, or an IDKs generated by the remote computer system. In these embodiments, act 505 operates to determine if context 312 at system 301 is in a known and trusted state.

In some embodiments, system 201 determines if a CVM firmware layer of the CVM matches (or is equivalent to) the CVM firmware layer sent to system 301 in act 412. Thus, in some embodiments, validating the security state of the remote computer system includes validating a virtualized firmware layer at the CVM. In some examples, system 201 may validate the CVM firmware layer based on a hash received from system 301, based on measurement information received from system 301, or based on receiving the CVM firmware layer itself. In these embodiments, act 505 operates to determine if context 314 at system 301 is in a known and trusted state.

Method 500a also comprises act 503 of initiating a migration of the CVM to the VM host. In some embodiments, act 503 comprises sending the CVM to the VM host. In some examples, migration component 320 communicates a guest state file, including a state of virtualized firmware 319, to system 201. In some examples, the migration component 320 communicates state disk 322 to system 201.

Method 500b may also comprise act 506 of cleaning the virtualized firmware layer of the CVM. In some examples, the migration orchestration component 318b removes and/or replaces (e.g., with default values) any non-encrypted or non-integrity-protected data within a virtualized firmware layer received from system 301. Thus, in some embodiments, cleaning the virtualized firmware layer of the CVM includes replacing non-encrypted or non-integrity-protected data from a virtualized firmware received from the remote computer system with local data.

In other examples, the migration orchestration component 318b replaces the virtualized firmware layer in its entirety (e.g., ignoring any virtualized firmware layer received from system 301). Thus, in some embodiments, cleaning the virtualized firmware layer of the CVM includes replacing a virtualized firmware received from the remote computer system with a local virtualized firmware.

Method 500b also comprises act 507 of starting the CVM. Notably, starting the CVM could include depending on the nature of act 506, act 507 could include booting a guest OS (e.g., if cleaning the virtualized firmware layer includes replacing it in its entirety), or doing a “live migration” boot that resumes execution of a guest OS based on runtime state received from system 301.

Thus, methods and systems are disclosed for migrating a CVM from a remote computer system to a VM host computer system. A method that is implemented in the VM host computer system for migrating a CVM from a remote computer system to a VM host computer system involves receiving a migration signal initiated by the remote computer system, validating the security state of the remote system, and upon validation, receiving the CVM from the remote system. The method further includes cleaning the virtualized firmware layer of the CVM and starting the CVM at the VM host computer system, ensuring a secure and confidential transfer of the CVM to the designated destination.

Alternatively, or in addition to the other examples described herein, examples include any combination of the following:
Clause 1. A method implemented by a virtualized firmware layer of a confidential virtual machine (CVM) that executes in a computer system that includes a processor system, the method comprising: receiving a signal to migrate the CVM to a remote computer system, the signal having been initiated by an orchestration component at a host partition of the computer system; validating a security state of the remote computer system; and after validating the security state of the remote computer system: removing a first secret from the virtualized firmware layer; encrypting a guest state file associated with the CVM using a second secret received from the remote computer system, the guest state file including a state of the virtualized firmware layer; and initiating a migration of the CVM to the remote computer system, including sending the guest state file to the remote computer system.
Clause 2. The method of clause 1, wherein validating the security state of the remote computer system comprises: obtaining measurement information from the remote computer system; sending the measurement information to an attestation service; and receiving an attestation status from the attestation service, wherein the attestation status indicates the security state of the remote computer system.
Clause 3. The method of clause 2, wherein obtaining the measurement information from the remote computer system includes receiving one or more of: a first claim associated with a trusted platform module (TPM) in the remote computer system; a second claim associated with a host operating system in the remote computer system; a secure boot status of the remote computer system; an identity encryption key (IDKe) generated by the remote computer system; or an identity signing key (IDKs) generated by the remote computer system.
Clause 4. The method of clause 3, wherein: obtaining the measurement information from the remote computer system includes receiving the IDKe; and encrypting the guest state file using the second secret received from the remote computer system comprises encrypting the guest state file with the IDKe.
Clause 5. The method of clause 1, wherein removing the first secret from the virtualized firmware layer includes removing one or more of, an attestation identity key (AIK) of a virtual TPM (vTPM) hosted by the virtualized firmware layer; a first certificate issued on the AIK of the vTPM; an endorsement key (EK) of the vTPM; or a second certificate issued by a hosting service provider.
Clause 6. The method of clause 1, wherein the signal is initiated by the orchestration component after a hosting service provider has verified ownership of the CVM by an identity associated with the remote computer system.
Clause 7. The method of clause 1, wherein receiving the signal to migrate the CVM to the remote computer system comprises receiving the signal at a virtual machine bus.
Clause 8. The method of clause 1, wherein initiating the migration of the CVM to the remote computer system also includes sending a virtual machine disk image to the remote computer system.
Clause 9. The method of clause 8, wherein the guest state file includes a data encryption key that enables access to data on the virtual machine disk image.
Clause 10. The method of clause 1, wherein the orchestration component is isolated from a host operating system executing in the host partition.
Clause 11. A method implemented in a computer system that includes a processor system and a trusted platform module (TPM), the method comprising: sending a request to a virtual machine (VM) hosting service for migrating a confidential virtual machine (CVM) that is executing at the VM hosting service to the computer system; sending measurement information to the VM hosting service, the measurement information including one or more of, a first claim associated with the TPM; a second claim associated with a host operating system (OS) in the computer system; a secure boot status of the computer system; an identity encryption key (IDKe) generated by the computer system; or an identity signing key (IDKs) generated by the computer system; receiving a guest state file from the VM hosting service, the guest state file including a first state of a first virtualized firmware layer instance of the CVM; and starting the CVM at the computer system based on the guest state file, including: creating a guest partition as the CVM, the guest partition including a first privilege context and a second privilege context, the first privilege context being restricted from accessing memory allocated to the second privilege context; starting a second virtualized firmware layer instance within the second privilege context, including creating a virtual TPM (vTPM) within the second virtualized firmware layer instance; and populating a second state of the second virtualized firmware layer instance from the guest state file.
Clause 12. The method of clause 11, wherein: the request is a first request; and the method further comprises receiving a second request from the VM hosting service, the second request for obtaining the measurement information.
Clause 13. The method of clause 11, wherein: the guest state file is encrypted with the IDKe; and the method further comprises decrypting the guest state file using the IDKe.
Clause 14. The method of clause 11, wherein the method further comprises receiving a virtual machine disk image from the VM hosting service.
Clause 15. The method of clause 14, wherein: the guest state file includes a data encryption key; and the method further comprises decrypting the virtual machine disk image with the data encryption key.
Clause 16. The method of clause 11, wherein: the measurement information is first measurement information; and the method further comprises, before starting the CVM at the computer system: sending second measurement information to an attestation service; and receiving an attestation status from the attestation service, wherein the attestation status indicates a security state of the computer system and enables the computer system to start the CVM.
Clause 17. The method of clause 11, wherein the method further comprises authenticating with the VM hosting service using an identity associated with the CVM.
Clause 18. The method of clause 11, wherein starting the CVM in the computer system is initiated by an orchestration component in a host partition of the computer system.
Clause 19. The method of clause 18, wherein the orchestration component is isolated from the host OS.
Clause 20. A system comprising: a virtual machine (VM) host computer system comprising a first processor system and a first computer storage medium that stores first computer-executable instructions that are executable by the first processor system to: receive a signal to migrate a CVM from the VM host computer system to a client computer system, the signal having been initiated by an orchestration component at a host partition of the VM host computer system; validate a security state of the client computer system based on measurement information received from the client computer system that includes a claim associated with a trusted platform module (TPM) in the client computer system; and after validating the security state of the client computer system: remove a first secret from a first virtualized firmware layer instance of the CVM; and send a guest state file to the client computer system, the guest state file including a state of the first virtualized firmware layer instance; and the client computer system, comprising a second processor system, the TPM, and a second computer storage medium that stores second computer-executable instructions that are executable by the second processor system to: send a request to a VM hosting service for migrating the CVM to the client computer system; send the measurement information to the VM host computer system; receive the guest state file from the VM host computer system; and start the CVM at the client computer system based on the guest state file, including: creating a guest partition as the CVM, the guest partition including a first privilege context and a second privilege context, the first privilege context being restricted from accessing memory allocated to the second privilege context; starting a second virtualized firmware layer instance within the second privilege context, including creating a virtual TPM (vTPM) within the second virtualized firmware layer instance; and populating a second state of the second virtualized firmware layer instance from the guest state file.
Clause 21. A method implemented in a virtual machine (VM) host computer system that includes a processor system, the method comprising: receiving a signal to migrate a confidential VM (CVM) from a remote computer system to the VM host computer system, the signal having been initiated by the remote computer system; validating a security state of the remote computer system; and based on validating the security state of the remote computer system, receiving the CVM from the remote computer system; cleaning a virtualized firmware layer of the CVM; and starting the CVM at the VM host computer system.
Clause 22. The method of clause 21, wherein validating the security state of the remote computer system includes: obtaining measurement information from the remote computer system; and determining if the obtaining measurement information matches prior measurement information received from the remote computer system.
Clause 23. The method of clause 22, wherein obtaining the measurement information from the remote computer system includes receiving one or more of: a first claim associated with a trusted platform module (TPM) in the remote computer system; a second claim associated with a host operating system in the remote computer system; a secure boot status of the remote computer system; an identity encryption key (IDKe) generated by the remote computer system; or an identity signing key (IDKs) generated by the remote computer system.
Clause 24. The method of clause 21, wherein validating the security state of the remote computer system includes validating a virtualized firmware layer at the CVM.
Clause 25. The method of clause 21, wherein cleaning the virtualized firmware layer of the CVM includes replacing non-encrypted or non-integrity-protected data from a virtualized firmware received from the remote computer system with local data.
Clause 26. The method of clause 21, wherein cleaning the virtualized firmware layer of the CVM includes replacing a virtualized firmware received from the remote computer system with a local virtualized firmware.
Clause 27. The method of clause 21, wherein starting the CVM at the VM host computer system includes booting a guest operating system within the CVM.
Clause 28. The method of clause 21, wherein starting the CVM at the VM host computer system includes initiating execution of a guest operating system within the CVM based on runtime state received from the remote computer system without booting the guest operating system.

Embodiments of the disclosure comprise or utilize a special-purpose or general-purpose computer system (e.g., system 201, system 301) that includes computer hardware, such as, for example, a processor system (e.g., processor system 203, processor system 303) and system memory (e.g., memory 204, memory 304), as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media (e.g., storage medium 205, storage medium 305). Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 206, network interface 306) and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (SaaS), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more virtual machines (VMs). During operation, VMs emulate an operational computing system, supporting an operating system (OS) and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented by a virtualized firmware layer of a confidential virtual machine (CVM) that executes in a computer system that includes a processor system, the method comprising:
receiving a signal to migrate the CVM to a remote computer system, the signal having been initiated by an orchestration component at a host partition of the computer system;
validating a security state of the remote computer system; and
after validating the security state of the remote computer system:
removing a first secret from the virtualized firmware layer;
encrypting a guest state file associated with the CVM using a second secret received from the remote computer system, the guest state file including a state of the virtualized firmware layer; and
initiating a migration of the CVM to the remote computer system, including sending the guest state file to the remote computer system.

2. The method of claim 1, wherein validating the security state of the remote computer system comprises:
obtaining measurement information from the remote computer system;
sending the measurement information to an attestation service; and
receiving an attestation status from the attestation service, wherein the attestation status indicates the security state of the remote computer system.

3. The method of claim 2, wherein obtaining the measurement information from the remote computer system includes receiving one or more of:
a first claim associated with a trusted platform module (TPM) in the remote computer system;
a second claim associated with a host operating system in the remote computer system;
a secure boot status of the remote computer system;
an identity encryption key (IDKe) generated by the remote computer system; or
an identity signing key (IDKs) generated by the remote computer system.

4. The method of claim 3, wherein:
obtaining the measurement information from the remote computer system includes receiving the IDKe; and
encrypting the guest state file using the second secret received from the remote computer system comprises encrypting the guest state file with the IDKe.

5. The method of claim 1, wherein removing the first secret from the virtualized firmware layer includes removing one or more of,
an attestation identity key (AIK) of a virtual TPM (vTPM) hosted by the virtualized firmware layer;
a first certificate issued on the AIK of the vTPM;
an endorsement key (EK) of the vTPM; or
a second certificate issued by a hosting service provider.

6. The method of claim 1, wherein the signal is initiated by the orchestration component after a hosting service provider has verified ownership of the CVM by an identity associated with the remote computer system.

7. The method of claim 1, wherein receiving the signal to migrate the CVM to the remote computer system comprises receiving the signal at a virtual machine bus.

8. The method of claim 1, wherein initiating the migration of the CVM to the remote computer system also includes sending a virtual machine disk image to the remote computer system.

9. The method of claim 8, wherein the guest state file includes a data encryption key that enables access to data on the virtual machine disk image.

10. The method of claim 1, wherein the orchestration component is isolated from a host operating system executing in the host partition.

11. A method implemented in a computer system that includes a processor system and a trusted platform module (TPM), the method comprising:
sending a request to a virtual machine (VM) hosting service for migrating a confidential virtual machine (CVM) that is executing at the VM hosting service to the computer system;
sending measurement information to the VM hosting service, the measurement information including one or more of,
a first claim associated with the TPM;
a second claim associated with a host operating system (OS) in the computer system;
a secure boot status of the computer system;
an identity encryption key (IDKe) generated by the computer system; or
an identity signing key (IDKs) generated by the computer system;
receiving a guest state file from the VM hosting service, the guest state file including a first state of a first virtualized firmware layer instance of the CVM; and
starting the CVM at the computer system based on the guest state file, including:
creating a guest partition as the CVM, the guest partition including a first privilege context and a second privilege context, the first privilege context being restricted from accessing memory allocated to the second privilege context;
starting a second virtualized firmware layer instance within the second privilege context, including creating a virtual TPM (vTPM) within the second virtualized firmware layer instance; and
populating a second state of the second virtualized firmware layer instance from the guest state file.

12. The method of claim 11, wherein:
the request is a first request; and
the method further comprises receiving a second request from the VM hosting service, the second request for obtaining the measurement information.

13. The method of claim 11, wherein:
the guest state file is encrypted with the IDKe; and
the method further comprises decrypting the guest state file using the IDKe.

14. The method of claim 11, wherein the method further comprises receiving a virtual machine disk image from the VM hosting service.

15. The method of claim 14, wherein:
the guest state file includes a data encryption key; and
the method further comprises decrypting the virtual machine disk image with the data encryption key.

16. The method of claim 11, wherein:
the measurement information is first measurement information; and
the method further comprises, before starting the CVM at the computer system:
sending second measurement information to an attestation service; and
receiving an attestation status from the attestation service, wherein the attestation status indicates a security state of the computer system and enables the computer system to start the CVM.

17. The method of claim 11, wherein the method further comprises authenticating with the VM hosting service using an identity associated with the CVM.

18. The method of claim 11, wherein starting the CVM in the computer system is initiated by an orchestration component in a host partition of the computer system.

19. The method of claim 18, wherein the orchestration component is isolated from the host OS.

20. A system comprising:
a virtual machine (VM) host computer system comprising a first processor system and a first computer storage medium that stores first computer-executable instructions that are executable by the first processor system to:
receive a signal to migrate a CVM from the VM host computer system to a client computer system, the signal having been initiated by an orchestration component at a host partition of the VM host computer system;
validate a security state of the client computer system based on measurement information received from the client computer system that includes a claim associated with a trusted platform module (TPM) in the client computer system; and
after validating the security state of the client computer system:
remove a first secret from a first virtualized firmware layer instance of the CVM; and
send a guest state file to the client computer system, the guest state file including a state of the first virtualized firmware layer instance; and
the client computer system, comprising a second processor system, the TPM, and a second computer storage medium that stores second computer-executable instructions that are executable by the second processor system to:
send a request to a VM hosting service for migrating the CVM to the client computer system;
send the measurement information to the VM host computer system;
receive the guest state file from the VM host computer system; and
start the CVM at the client computer system based on the guest state file, including:
creating a guest partition as the CVM, the guest partition including a first privilege context and a second privilege context, the first privilege context being restricted from accessing memory allocated to the second privilege context;
starting a second virtualized firmware layer instance within the second privilege context, including creating a virtual TPM (vTPM) within the second virtualized firmware layer instance; and
populating a second state of the second virtualized firmware layer instance from the guest state file.
